(19) United States
(12) Patent Application Publication
(10) Pub. No.: US 2019/0149569 A1
(43) Pub. Date: May 16, 2019

(54) SECURITY MONITORING DEVICE, COMMUNICATION SYSTEM, SECURITY MONITORING METHOD, AND COMPUTER READABLE MEDIUM

(71) Applicant: MITSUBISHI ELECTRIC CORPORATION, Tokyo (JP)

(72) Inventors: Shigeki KITAZAWA, Tokyo (JP); Yukio IZUMI, Tokyo (JP); Tomonori NEGI, Tokyo (JP); Kiyoto KAWAUCHI, Tokyo (JP)

(73) Assignee: MITSUBISHI ELECTRIC CORPORATION, Tokyo (JP)

(21) Appl. No.: 16/302,963

(22) PCT Filed: Jun. 15, 2016
(86) PCT No.: PCT/JP2016/067802

§ 371 Date: Nov. 19, 2018

(51) Int. Cl. H04L 29/06; G06F 21/62

(52) U.S. Cl. CPC H04L 63/1425; H04L 63/0876; G06F 21/6218

(57) ABSTRACT

An electronic file copy notification reception unit acquires identification information on a terminal device connected to a first network switch to which a file server is connected, as first identification information, when the terminal device acquires a copy of an electronic file from the file server. A determination instruction unit acquires identification information on a device, as second identification information, when the device is newly connected to a second network switch different from the first network switch. The determination instruction unit matches the first identification information with the second identification information and instructs the second network switch to restrict communication to and from the terminal device via the second network switch in case where the first identification information coincides with the second identification information.

### TECHNICAL FIELD

The present invention relates to a security monitoring device and the like.

### BACKGROUND ART

Patent Literature 1 discloses a technique in which, upon an access request from a terminal device for an electronic file saved in a file server, a security policy management server determines accessibility or inaccessibility to the electronic file.

More specifically, Patent Literature 1 discloses the technique in which the security policy management server determines the accessibility or inaccessibility to the electronic file for which the access request has been made, based on operation definition data in which the accessibility or inaccessibility is defined for each degree of importance of electronic files and a degree of importance of the electronic file for which the access request has been made.

### CITATION LIST

### Patent Literature

Patent Literature 1: JP 5740260

### SUMMARY OF INVENTION

### Technical Problem

In the technique of Patent Literature 1, in case where a terminal device makes a connection with a network that is outside control of the security policy management device after the terminal device acquires a copy of an electronic file from the file server, the security policy management device is incapable of controlling access to the electronic file. Therefore, the technique of Patent Literature 1 has a problem in that leakage of an electronic file to outside may not be prevented in case where a terminal device having acquired a copy of the electronic file makes a connection with a network that is outside the control of the security policy management device.

The present invention mainly aims at settling such a problem. That is, the present invention has its major object to avoid a situation in which such an electronic file leaks from the terminal device to the outside.

### Solution to Problem

A security monitoring device according to the present invention includes:

a first identification information acquisition unit to acquire identification information on a terminal device connected to a first network switch to which a file server is connected, as first identification information, when the terminal device acquires a copy of an electronic file from the file server;

a second identification information acquisition unit to acquire identification information on a device, as second identification information, when the device is newly connected to a second network switch different from the first network switch; and

a restriction instruction unit to match the first identification information with the second identification information and to instruct the second network switch to restrict communication to and from the terminal device via the second network switch in case where the first identification information coincides with the second identification information.

### Advantageous Effects of Invention

In the present invention, in case where a terminal device having acquired a copy of an electronic file from the file server makes a connection with the second network switch, communication to and from the terminal device via the second network switch may be restricted. According to the present invention, therefore, a situation in which the electronic file leaks from the terminal device to the outside may be avoided.

### BRIEF DESCRIPTION OF DRAWINGS

FIG. 1 is a diagram illustrating a system configuration example according to Embodiment 1.

FIG. 2 is a diagram illustrating an example of management of electronic files in a file server according to Embodiment 1.

FIG. 3 is a diagram illustrating an example of a transfer of a terminal device according to Embodiment 1.

FIG. 4 is a diagram illustrating an example of a confidentiality retaining terminal record table according to Embodiment 1.

FIG. 5 is a flowchart illustrating an example of operations of the file server according to Embodiment 1.

FIG. 6 is a flowchart illustrating an example of operations of a security monitoring device according to Embodiment 1.

FIG. 7 is a flowchart illustrating an example of operations of a second network switch according to Embodiment 1.

FIG. 8 is a flowchart illustrating an example of operations of the security monitoring device according to Embodiment 1.

FIG. 9 is a flowchart illustrating an example of operations of the security monitoring device according to Embodiment 1.

FIG. 10 is a diagram illustrating a system configuration example according to Embodiment 2.

FIG. 11 is a diagram illustrating a system configuration example according to Embodiment 3.

FIG. 12 is a diagram illustrating a hardware configuration example of the security monitoring device according to Embodiments 1 to 3.

### DESCRIPTION OF EMBODIMENTS

Hereinbelow, embodiments of the present invention will be described with use of the drawings. In following descriptions and the drawings on the embodiments, elements provided with identical reference characters represent identical parts or corresponding parts.

### Embodiment 1

*** Description on Configurations ***

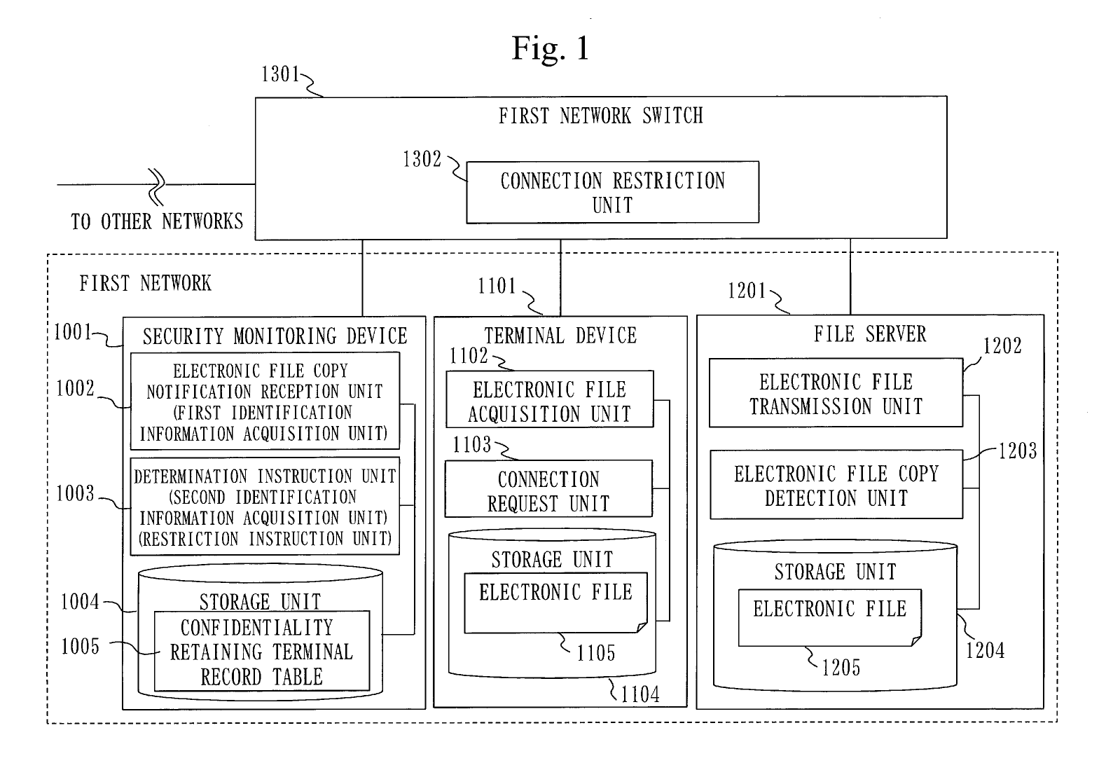

FIG. 1 illustrates a system configuration example according to the present embodiment.

As illustrated in FIG. 1, a security monitoring device 1001, a terminal device 1101, and a file server 1201 are connected to a first network switch 1301. In other words, the security monitoring device 1001, the terminal device 1101, and the file server 1201 belong to a first network configured with the first network switch 1301.

The file server 1201 retains an electronic file 1205.

The file server 1201 transmits a copy of the electronic file 1205 to the terminal device 1101 in response to a request from the terminal device 1101. The electronic file 1205 may be an electronic file in which confidential information is included (which will be referred to as a confidential electronic file) or an electronic file in which confidential information is not included.

The terminal device 1101 requests the copy of the electronic file 1205 to the file server 1201 and receives the copy of the electronic file 1205 from the file server 1201. The terminal device 1101 then retains the received electronic file 1205 as an electronic file 1105.

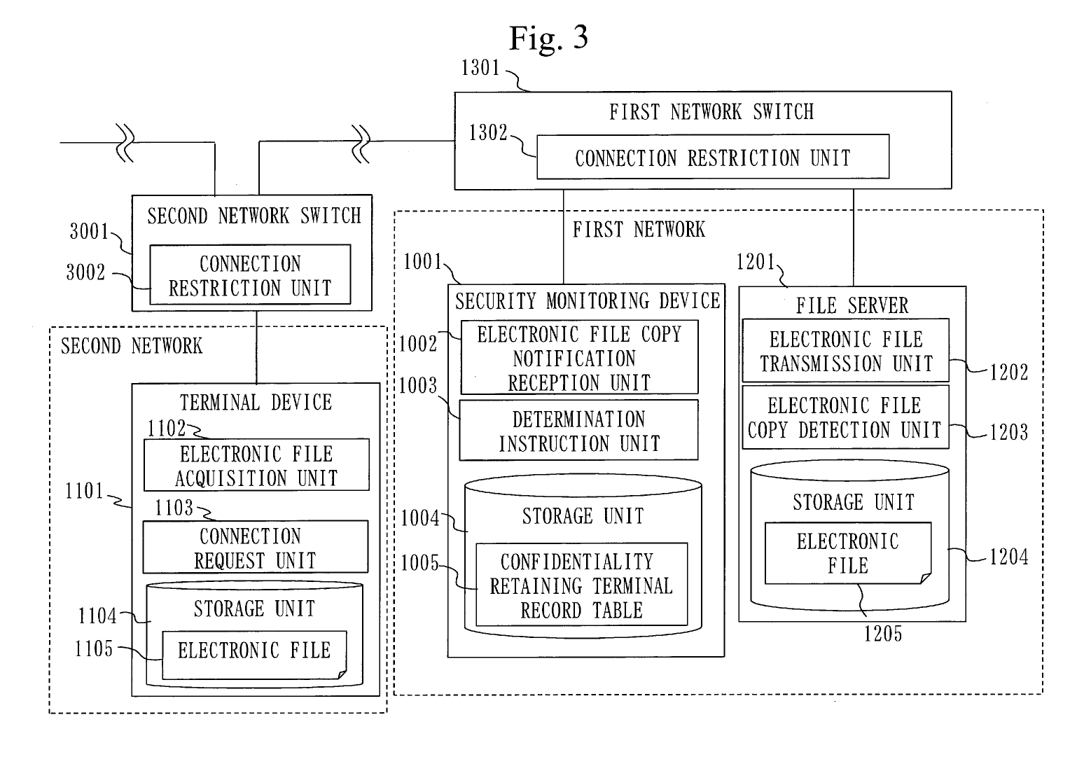

Though the terminal device 1101 is connected to the first network switch 1301 in FIG. 1, the terminal device 1101 may be connected to a second network switch 3001 different from the terminal device 1101 with connection with the first network switch 1301 canceled as illustrated in FIG. 3. When the terminal device 1101 is connected to the second network switch 3001, the terminal device 1101 belongs to a second network.

When the copy of the confidential electronic file is transmitted from the file server 1201 to the terminal device 1101, the security monitoring device 1001 acquires identification information on the terminal device 1101 and stores the acquired identification information on the terminal device 1101.

The security monitoring device 1001 receives identification information on a device newly connected to the second network switch 3001, from the second network switch 3001.

Then the security monitoring device 1001 matches the identification information received from the second network switch 3001, with the stored identification information on the terminal device 1101. In case where the identification information received from the second network switch 3001 coincides with the identification information on the terminal device 1101, the electronic file 1105 in which confidential information is included may leak from the terminal device 1101. Therefore, the security monitoring device 1001 instructs the second network switch 3001 to control communication to and from the terminal device 1101.

Operations that are carried out by the security monitoring device 1001 correspond to the security monitoring method.

A combination of the security monitoring device 1001 and the terminal device 1101 corresponds to the communication system.

Subsequently, components of the terminal device 1101, the file server 1201, the security monitoring device 1001, the first network switch 1301, and the second network switch 3001 will be described.

In the terminal device 1101, an electronic file acquisition unit 1102 transmits a copy request that is a request to transmit the copy of the electronic file 1205, to the file server 1201.

The electronic file acquisition unit 1102 receives, from the file server 1201, the copy of the electronic file 1205 transmitted in response to the copy request and stores the received copy of the electronic file 1205 as the electronic file 1105 in a storage unit 1104.

When the terminal device 1101 is connected to the second network switch 3001 as illustrated in FIG. 3, a connection request unit 1103 transmits a network connection request that is a request to enable communication with other devices in the second network or devices out of the second network, to the second network switch 3001.

The storage unit 1104 stores the electronic file 1105 that is the copy of the electronic file 1205.

In the file server 1201, an electronic file transmission unit 1202 receives the copy request transmitted from the terminal device 1101. The electronic file transmission unit 1202 notifies an electronic file copy detection unit 1203 of identification information on the electronic file 1205 the copy of which is requested in the copy request.

The electronic file transmission unit 1202 makes the copy of the electronic file 1205 in accordance with the copy request and transmits the copy of the electronic file 1205 to the terminal device 1101.

The electronic file copy detection unit 1203 determines whether the electronic file 1205 to be copied is the confidential electronic file or not, based on the identification information that is notification from the electronic file transmission unit 1202.

In case where the electronic file 1205 to be copied is the confidential electronic file, the electronic file copy detection unit 1203 transmits electronic file copy notification to the security monitoring device 1001. The identification information on the terminal device 1101 is included in the electronic file copy notification.

A storage unit 1204 stores the electronic file 1205. Though only the one electronic file 1205 is illustrated in FIG. 1, the storage unit 1204 may store a plurality of electronic files 1205.

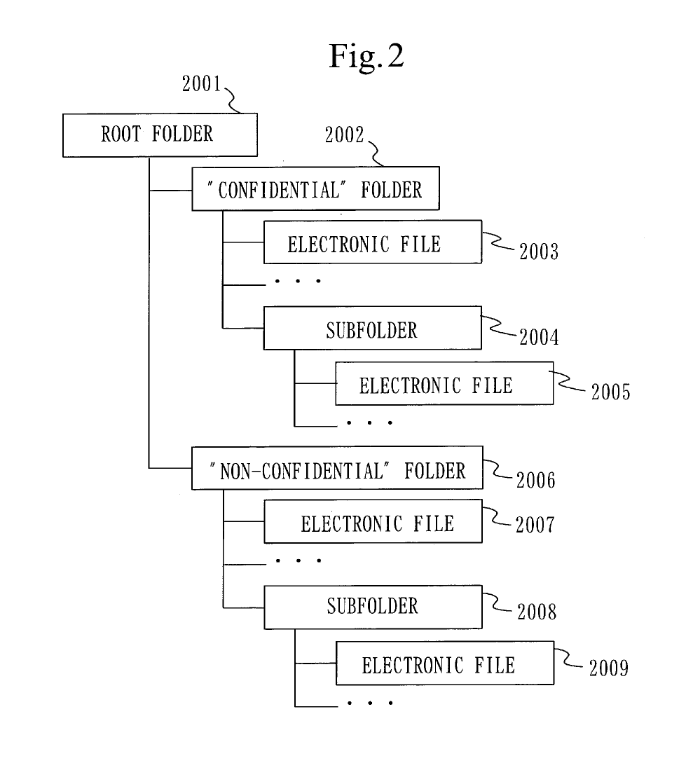

The electronic files 1205 stored in the storage unit 1204 are managed based on a tree-shaped configuration as illustrated in FIG. 2.

In FIG. 2, a “confidential” folder 2002 and a “non-confidential” folder 2006 are below a root folder 2001.

The “confidential” folder 2002 is composed of an electronic file 2003 in which confidential information is recorded, a subfolder 2004 including an electronic file 2005 in which confidential information is recorded, and the like. That is, the electronic files 2003, 2005, and the like in which the confidential information is included are saved in the “confidential” folder 2002. The electronic files 2003, 2005, and the like including the confidential information correspond to the confidential electronic files.

The “non-confidential” folder 2006 is also composed of electronic files 2003, 2009, and the like, a subfolder 2008, and the like. No confidential information is included in the electronic files 2003, 2009, and the like that are saved in the “non-confidential” folder 2006.

When the electronic file 1205 is saved in the storage unit 1204, a user of the file server 1201 determines in which of the “confidential” folder 2002 and the “non-confidential” folder 2006 the electronic file 1205 is to be saved. The file server 1201 may determine in which of the “confidential” folder 2002 and the “non-confidential” folder 2006 the electronic file 1205 is to be saved. For determination by the file server 1201, the file server 1201 checks whether any character string related to confidentiality is included in the electronic file 1205 to be saved or not. The electronic file 1205 in which any character string related to the confidentiality is included is saved in the “confidential” folder 2002. The electronic file 1205 in which any character string related to the confidentiality is not included is saved in the “non-confidential” folder 2006.

In the security monitoring device 1001, an electronic file copy notification reception unit 1002 receives the electronic file copy notification transmitted from the file server 1201. The electronic file copy notification reception unit 1002 registers the identification information on the terminal device 1101, included in the electronic file copy notification, in a confidentiality retaining terminal record table 1005. That is, the electronic file copy notification reception unit 1002 stores the identification information on the terminal device 1101 in a storage unit 1004.

The electronic file copy notification reception unit 1002 corresponds to the first identification information acquisition unit. The identification information on the terminal device 1101 included in the electronic file copy notification corresponds to the first identification information. Operations that are carried out by the electronic file copy notification reception unit 1002 correspond to the first identification information acquisition process.

A determination instruction unit 1003 receives a network connection query transmitted from the second network switch 3001 illustrated in FIG. 3. The identification information on the device newly connected to the second network switch 3001 is included in the network connection query.

The determination instruction unit 1003 matches the identification information included in the network connection query with the identification information on the terminal device 1101 registered in the confidentiality retaining terminal record table 1005. In case where the identification information included in the network connection query coincides with the identification information on the terminal device 1101 registered in the confidentiality retaining terminal record table 1005, the determination instruction unit 1003 instructs the second network switch 3001 to restrict the communication to and from the terminal device 1101.

The determination instruction unit 1003 corresponds to the second identification information acquisition unit and the restriction instruction unit. The identification information included in the network connection query corresponds to the second identification information. Operations that are carried out by the determination instruction unit 1003 correspond to the second identification information acquisition process and the restriction instruction process.

The storage unit 1004 stores the confidentiality retaining terminal record table 1005.

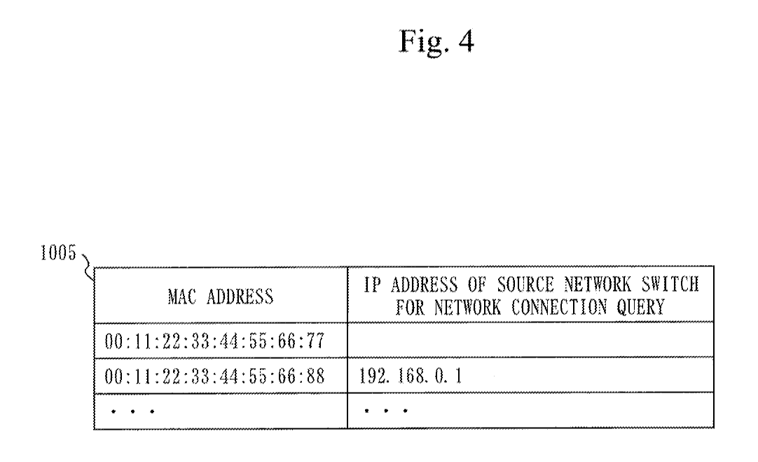

FIG. 4 illustrates an example of the confidentiality retaining terminal record table 1005. In the confidentiality retaining terminal record table 1005 of FIG. 4, MAC (Media Access Control) addresses of terminal devices are registered as identification information on the terminal devices.

When the determination instruction unit 1003 receives the network connection query, an IP (Internet Protocol) address of a source network switch for the network connection query is registered so as to correspond to the MAC address of the terminal device indicated by the notification of the network connection query.

In the first network switch 1301, a connection restriction unit 1302 controls communication to and from the devices included in the first network.

In the second network switch 3001 of FIG. 3, similarly, a connection restriction unit 3002 controls communication to and from the devices included in the second network. Specifically, the connection restriction unit 3002 restricts communication of the terminal device 1101 with another device in the second network or with a device in another network when instructed from the security monitoring device 1001 to restrict the communication to and from the terminal device 1101. That is, the connection restriction unit 3002 does not relay the communication between the terminal device 1101 and another device. The connection restriction unit 3002 lifts restriction on the communication to and from the terminal device 1101 when instructed from the security monitoring device 1001 to lift the restriction on the communication to and from the terminal device 1101. That is, the connection restriction unit 3002 relays the communication between the terminal device 1101 and another device.

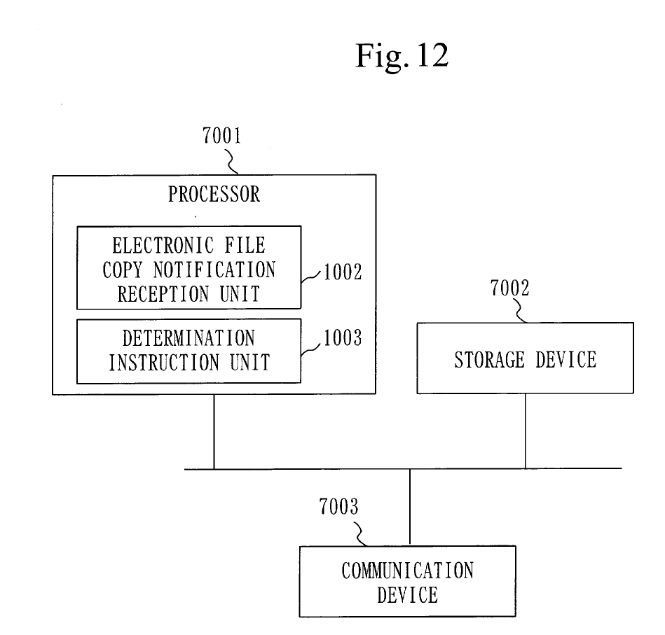

FIG. 12 illustrates a hardware configuration example of the security monitoring device 1001.

The security monitoring device 1001 is a computer that includes a processor 7001, a storage device 7002, and a communication device 7003.

In the storage device 7002, programs that fulfil functions of the electronic file copy notification reception unit 1002 and the determination instruction unit 1003 that are illustrated in FIG. 1 are stored.

The processor 7001 executes the programs and thereby carries out operations of the electronic file copy notification reception unit 1002 and the determination instruction unit 1003. The programs that fulfil the functions of the electronic file copy notification reception unit 1002 and the determination instruction unit 1003 correspond to the security monitoring program.

FIG. 12 schematically represents a state in which the processor 7001 executes the programs that fulfil the functions of the electronic file copy notification reception unit 1002 and the determination instruction unit 1003, that is, a state in which the processor 7001 operates as the electronic file copy notification reception unit 1002 and the determination instruction unit 1003.

The storage device 7002 implements the storage unit 1004 illustrated in FIG. 1.

The communication device 7003 is a circuit that communicates with the first network switch 1301.

*** Description on Operations ***

Subsequently, examples of operations of the security monitoring device 1001, the terminal device 1101, the file server 1201, and the second network switch 3001 according to the embodiment will be described.

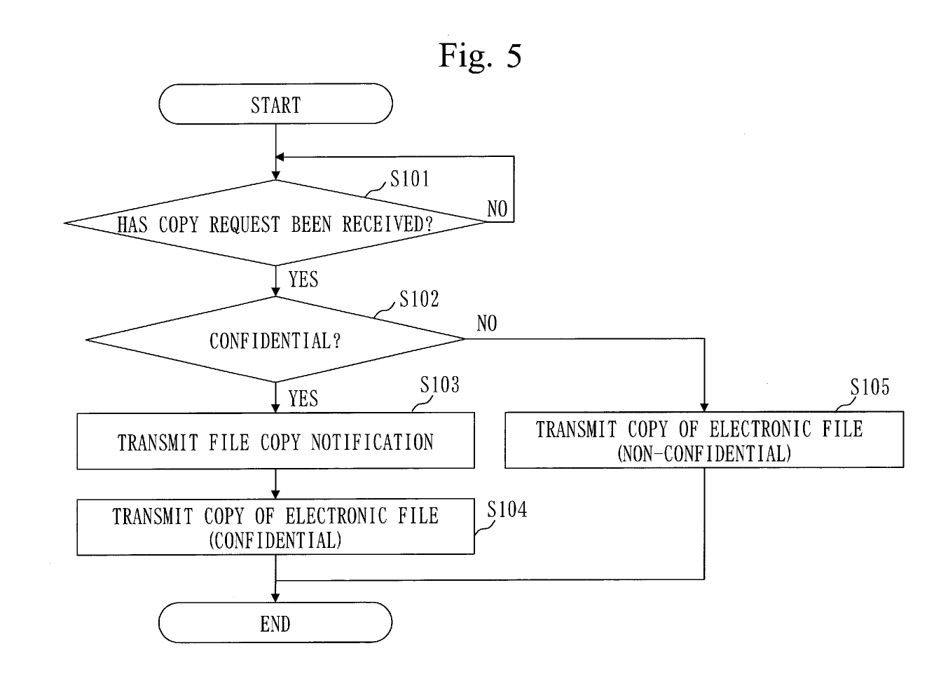

With reference to FIG. 5, initially, the example of the operations of the file server 1201 will be described.

In the file server 1201, the electronic file transmission unit 1202 receives the copy request from the terminal device 1101 (YES in step S101). In the copy request, the MAC address of the source terminal device 1101 and the identification information on the electronic file 1205 to be copied are included. The identification information on the electronic file 1205 is a file name, for instance.

The electronic file transmission unit 1202 outputs the identification information on the electronic file 1205 included in the copy request to the electronic file copy detection unit 1203.

The electronic file copy detection unit 1203 acquires the identification information on the electronic file 1205 from the electronic file transmission unit 1202 and determines whether the electronic file 1205 the copy of which is requested by the terminal device 1101 is the confidential electronic file or not, based on the acquired identification information (step S102).

The identification information on the electronic file 1205 is the file name, for instance. Thus the electronic file copy detection unit 1203 analyzes a file structure illustrated in FIG. 2 and thereby determines whether the electronic file 1205 the copy of which is requested is included in the “confidential” folder 2002 or the “non-confidential” folder 2006.

In case where the electronic file 1205 to be copied is the confidential electronic file (YES in step S102), the electronic file copy detection unit 1203 transmits file copy notification (step S104). In the file copy notification, the MAC address of the source terminal device 1101 for the copy request is included.

Subsequently, the electronic file transmission unit 1202 makes the copy of the electronic file 1205 the copy of which is requested by the terminal device 1101 and which is the confidential electronic file and transmits the copy of the electronic file 1205 that has been made, to the terminal device 1101 (step S104).

On the other hand, in case of NO in step S102, that is, in case where the electronic file 1205 the copy of which is requested by the terminal device 1101 is not the confidential electronic file, the electronic file transmission unit 1202 makes the copy of the electronic file 1205 the copy of which is requested by the terminal device 1101 and transmits the copy of the electronic file 1205 that has been made, to the terminal device 1101 (step S105).

Through above procedures, the electronic file acquisition unit 1102 of the terminal device 1101 receives the copy of the electronic file 1205 and stores the received copy of the electronic file 1205 as the electronic file 1105 in the storage unit 1104.

In FIG. 5, the copy of the electronic file 1205 is transmitted after the file copy notification is transmitted. This sequence, however, may be inverted or transmission of the file copy notification and transmission of the copy of the electronic file 1205 may be carried out in parallel.

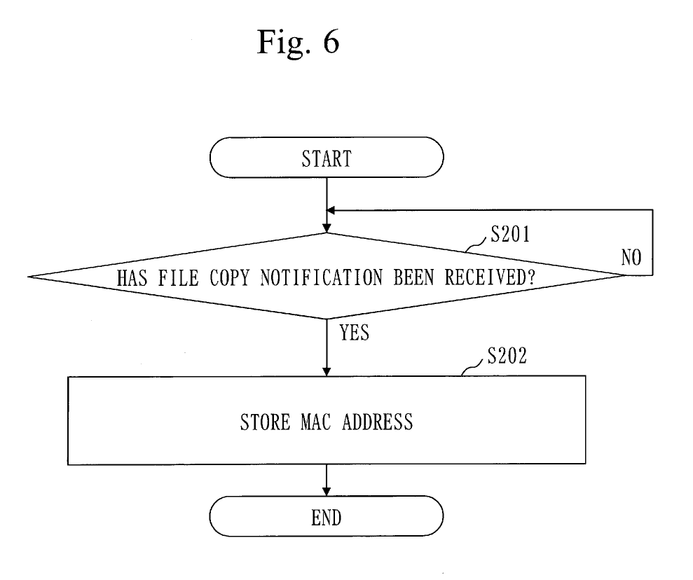

With reference to FIG. 6, subsequently, an example of operations of the security monitoring device 1001 upon transmission of the file copy notification from the file server 1201 will be described.

In the security monitoring device 1001, the electronic file copy notification reception unit 1002 receives the file copy notification transmitted from the file server 1201 (step S201).

The electronic file copy notification reception unit 1002 registers the MAC address of the terminal device 1101, included in the file copy notification, in the confidentiality retaining terminal record table 1005 (FIG. 4).

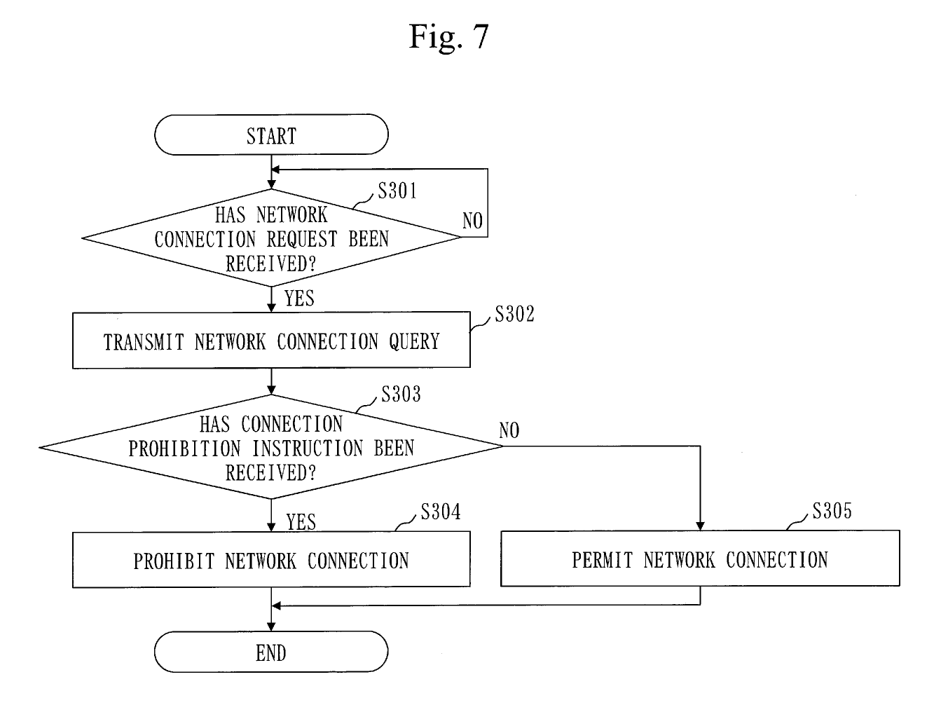

With reference to FIG. 7, subsequently, the example of the operations of the second network switch 3001 upon connection of the terminal device 1101 to the second network switch 3001 will be described.

In the second network switch 3001, the connection restriction unit 3002 receives the network connection request from the connection request unit 1103 of the terminal device 1101 (YES in step S301). In the network connection request, the MAC address of the terminal device 1101 is included.

Subsequently, the connection restriction unit 3002 transmits the network connection query to the security monitoring device 1001 (step S302).

In the network connection query, the MAC address of the terminal device 1101 is included as the identification information on the device newly connected to the second network switch 3001. An IP address of the second network switch 3001 is also included in the network connection query.

The network connection query reaches the security monitoring device 1001 via the first network switch 1301.

Subsequently, when receiving a response to the network connection query from the security monitoring device 1001, the connection restriction unit 3002 determines whether the received response is a connection prohibition instruction or a connection permission instruction (step S303).

In case where the response received from the security monitoring device 1001 is the connection prohibition instruction (YES in step S303), the connection restriction unit 3002 prohibits network connection of the terminal device 1101 (step S304). In the connection prohibition instruction, the MAC address of the terminal device 1101 is included. The connection restriction unit 3002 prohibits the network connection of the terminal device 1101 by managing a packet filtering policy with use of the MAC address included in the connection prohibition instruction, for instance.

As a result, the terminal device 1101 is permitted to communicate only with the security monitoring device 1001 and is neither permitted to communicate with the other devices in the second network nor devices in the other networks other than the second network.

On the other hand, in case where the response received from the security monitoring device 1001 is the connection permission instruction (NO in step S303), the connection restriction unit 3002 permits the network connection of the terminal device 1101 (step S305). In the connection permission instruction, the MAC address of the terminal device 1101 is included. The connection restriction unit 3002 permits the network connection of the terminal device 1101 by managing the packet filtering policy with use of the MAC address included in the connection permission instruction, for instance.

As a result, the terminal device 1101 can communicate with any device in the second network and any device in the other networks other than the second network.

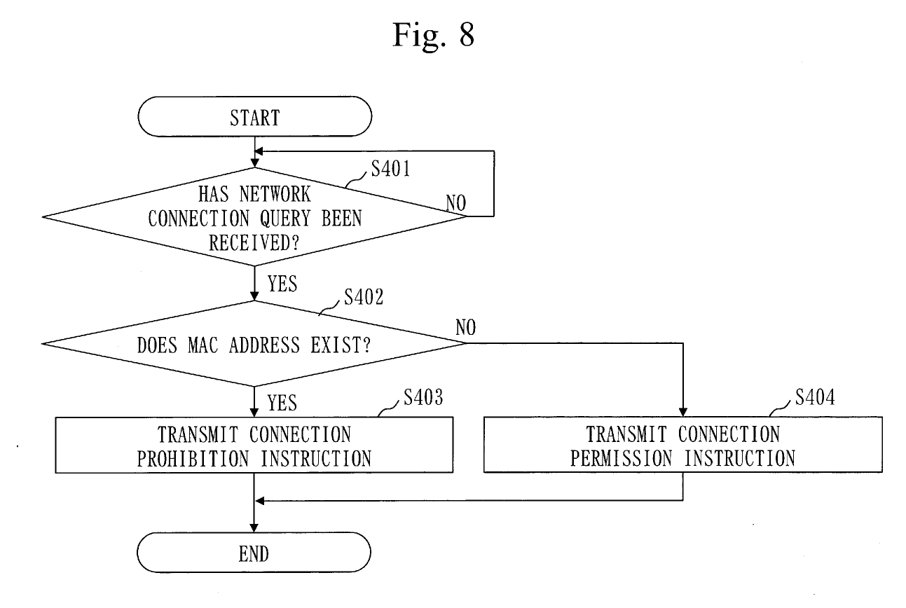

With reference to FIG. 8, subsequently, an example of operations of the security monitoring device 1001 upon reception of the network connection query from the second network switch 3001 will be described.

In the security monitoring device 1001, the determination instruction unit 1003 receives the network connection query from the second network switch 3001 (YES in step S401).

The determination instruction unit 1003 matches the MAC address that is the notification from the second network switch 3001 with the MAC addresses that are managed in the confidentiality retaining terminal record table 1005 (step S402).

In case where the MAC address that coincides with the MAC address as the notification from the second network switch 3001 exists in the MAC addresses that are managed in the confidentiality retaining terminal record table 1005 (YES in step S402), the determination instruction unit 1003 transmits the connection prohibition instruction to the second network switch 3001 because there is a high probability that the terminal device 1101 retains the confidential electronic file (step S403). The connection prohibition instruction is a command for an instruction for prohibition on the communication to and from the terminal device 1101. The connection prohibition instruction reaches the second network switch 3001 via the first network switch 1301.

On the other hand, in case where the MAC address that coincides with the MAC address as the notification from the second network switch 3001 does not exist in the MAC addresses that are managed in the confidentiality retaining terminal record table 1005 (YES in step S402), the determination instruction unit 1003 transmits the connection permission instruction to the second network switch 3001 because the terminal device 1101 does not retain the confidential electronic file (step S404). The connection permission instruction is a command for an instruction for permission for the communication to and from the terminal device 1101. The connection permission instruction reaches the second network switch 3001 via the first network switch 1301.

The determination instruction unit 1003 registers the IP address of the second network switch 3001 that is a source of the network connection query, in the confidentiality retaining terminal record table 1005, with the IP address mapped to the corresponding MAC address. The IP address of the second network switch 3001 is included in the network connection query.

On condition that the communication to and from the terminal device 1101 is prohibited, a user of the terminal device 1101 who needs to communicate with a device in the second network or a device in another network deletes the confidential electronic file from the storage unit 1104. Then the user of the terminal device 1101 manually transmits file deletion notification from the terminal device 1101.

In the file deletion notification, the MAC address of the terminal device 1101 is included.

The file deletion notification reaches the second network switch 3001. The second network switch 3001 adds the IP address of the second network switch 3001 to the file deletion notification and transmits the file deletion notification, to which the IP address of the second network switch 3001 has been added, to the security monitoring device 1001.

The file deletion notification reaches the security monitoring device 1001 via the first network switch 1301.

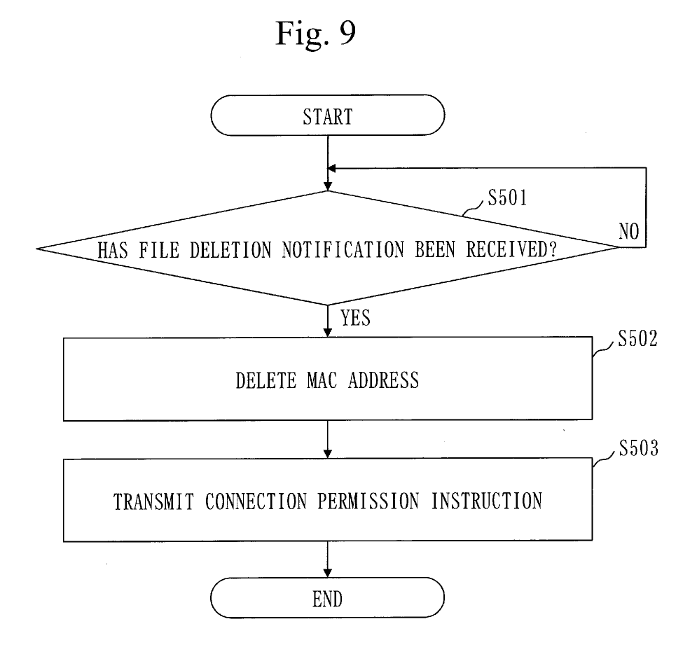

With reference to FIG. 9, subsequently, an example of operations of the security monitoring device 1001 upon reception of the file deletion notification will be described.

In the security monitoring device 1001, the determination instruction unit 1003 receives the file deletion notification (YES in step S501).

Subsequently, the determination instruction unit 1003 extracts a record in which a pair of the MAC address of the terminal device 1101 included in the file deletion notification and the IP address of the second network switch 3001 is described, from the confidentiality retaining terminal record table 1005 and deletes the extracted record (step S502).

Finally, the determination instruction unit 1003 transmits the connection permission instruction for the instruction for the permission for the communication to and from the terminal device 1101, to the second network switch 3001. The connection permission instruction reaches the second network switch 3001 via the first network switch 1301.

The second network switch 3001 lifts the restriction on the communication to and from the terminal device 1101, based on the connection permission instruction. The second network switch 3001 removes prohibition on the network connection of the terminal device 1101 by managing the packet filtering policy, for instance.

### Description on Effects of Embodiment

In the embodiment, as described above, the security monitoring device restricts the network connection of the terminal device that retains the confidential electronic file. Thus the situation in which the confidential electronic file copied from the file server to the terminal device leaks may be avoided.

### Embodiment 2

In Embodiment 1, when the restriction on the network connection needs to be lifted, the user has to manually transmit the file deletion notification to the security monitoring device 1001.

In the present embodiment, the terminal device 1101 detects deletion of the confidential electronic file and transmits the file deletion notification to the security monitoring device 1001.

*** Description on Configurations ***

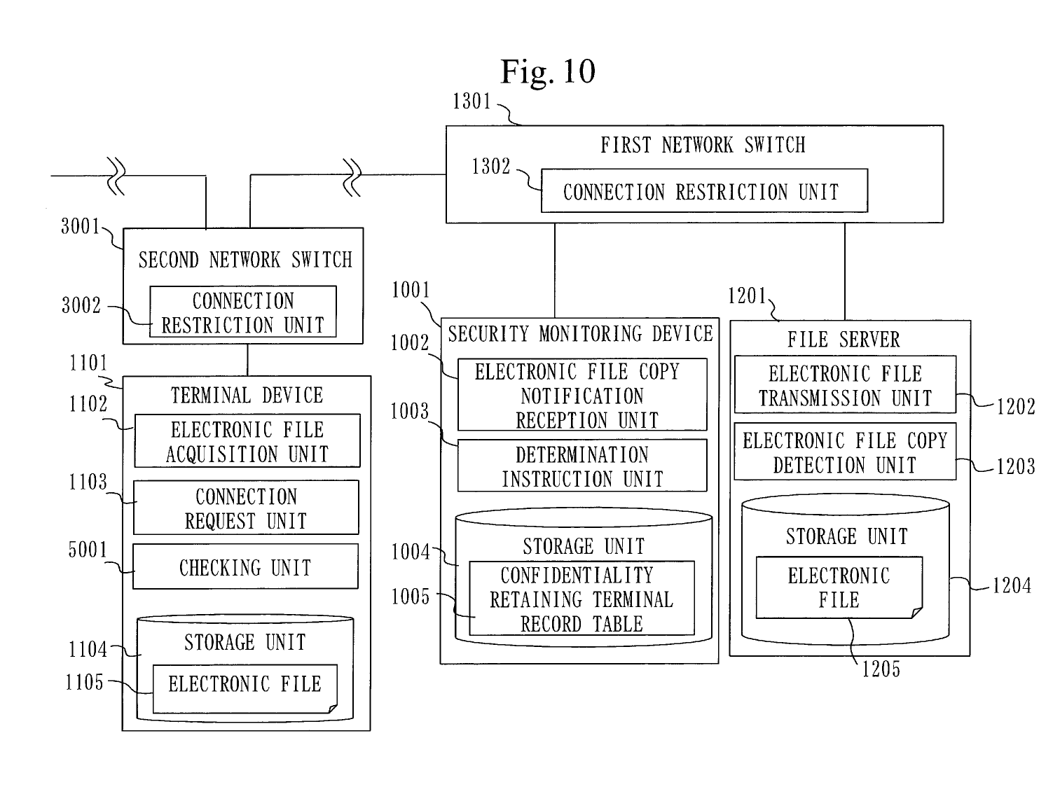

FIG. 10 illustrates a system configuration example according to the present embodiment.

In FIG. 10, a checking unit 5001 is added to the terminal device 1101, in comparison with FIG. 3. The other components are the same as components in FIG. 3. The hardware configuration example of the security monitoring device 1001 is as illustrated in FIG. 12.

The checking unit 5001 checks whether the confidential electronic file has been deleted from the storage unit 1104 or not. In case where the confidential electronic file has been deleted from the storage unit 1104, the checking unit 5001 notifies the security monitoring device 1001 that the confidential electronic file has been deleted from the terminal device 1101.

Hereinbelow, differences from Embodiment 1 will be principally described. Matters that will not be described below are the same as those in Embodiment 1.

*** Description on Operations ***

In the checking unit 5001, character strings such as “internal use only” and “confidential” related to confidential information have been registered in advance. The checking unit 5001 scans the electronic file 1105 saved in the storage unit 1104 and thereby checks whether any character string related to the confidential information is included in the electronic file 1105 or not. In case where any character string related to the confidential information is not included in the electronic file 1105 saved in the storage unit 1104, as a result of checking, the checking unit 5001 determines that the confidential electronic file has been deleted. The checking unit 5001 then transmits the file deletion notification for notification that the electronic file (confidential electronic file) in which the character string related to the confidential information is included has been deleted, to the security monitoring device 1001.

The checking unit 5001 may acquire the file name of the confidential electronic file from the security monitoring device 1001 or the file server 1201 and may check whether the electronic file 1105 that has the same file name as the acquired file name of the confidential electronic file exists in the storage unit 1104 or not. In case where the electronic file 1105 that has the same file name as the file name of the confidential electronic file does not exist in the storage unit 1104, as a result of checking, the checking unit 5001 determines that the confidential electronic file has been deleted. The checking unit 5001 then transmits the file deletion notification for notification that the electronic file (confidential electronic file) having the same file name as the file name of the confidential electronic file has been deleted, to the security monitoring device 1001.

The file deletion notification is the same as the file deletion notification described in Embodiment 1. Operations posterior to reception of the file deletion notification by the security monitoring device 1001 are the same as the operations described in Embodiment 1 and description is omitted.

### Description on Effects of Embodiment

In the present embodiment, as described above, the file deletion notification is automatically transmitted from the terminal device when the confidential electronic file is deleted from the terminal device. Upon deletion of the confidential electronic file, therefore, the terminal device is immediately made possible to communicate with the other devices in the second network or with devices in the other networks.

### Embodiment 3

In the present embodiment, the terminal device 1101 checks whether the confidential electronic file has been deleted or not, with use of a digital watermark embedded in the electronic file.

*** Description on Configurations ***

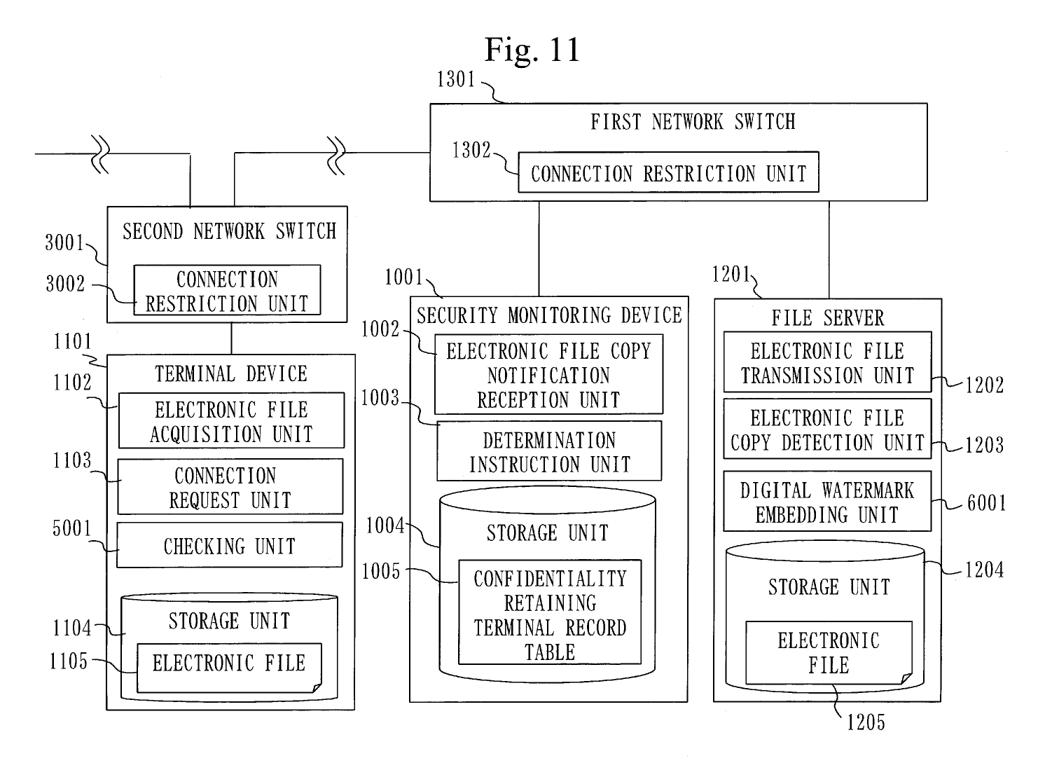

FIG. 11 illustrates a system configuration example according to the present embodiment.

In FIG. 11, a digital watermark embedding unit 6001 is added to the file server 1201, in comparison with FIG. 10.

The digital watermark embedding unit 6001 embeds the digital watermark in the confidential electronic file. The digital watermark is a “watermark” that is applied to electronic data and various studies are currently and vigorously conducted on a technique of the digital watermark. A type of the digital watermark the digital watermark embedding unit 6001 embeds in the confidential electronic file does not matter.

In the embodiment, the checking unit 5001 determines that the confidential electronic file has been deleted from the storage unit 1104 in case where any electronic file in which the digital watermark is embedded cannot be detected in the storage unit 1104. Then the checking unit 5001 notifies the security monitoring device 1001 that the confidential electronic file has been deleted from the storage unit 1104.

The other components are the same as the components in FIG. 10. The hardware configuration example of the security monitoring device 1001 is as illustrated in FIG. 12.

Hereinbelow, differences from Embodiment 1 and Embodiment 2 will be principally described. Matters that will not be described below are the same as those in Embodiment 1 and Embodiment 2.

*** Description on Operations ***

In the file server 1201, in case where the electronic file copy detection unit 1203 determines that the electronic file the copy of which is requested by the terminal device 1101 is the confidential electronic file, the digital watermark embedding unit 6001 embeds the digital watermark in the copy of the electronic file 1205 that has been made by the electronic file transmission unit 1202. The electronic file transmission unit 1202 then transmits the copy of the electronic file 1205 in which the digital watermark is embedded, to the terminal device 1101.

In the terminal device 1101, the electronic file acquisition unit 1102 stores, in the storage unit 1104, the copy of the electronic file 1205 in which the digital watermark is embedded, as the electronic file 1105. That is, the digital watermark is embedded in the electronic file 1105 which is retained in the terminal device 1101 and in which the confidential information is included. In other words, the electronic file 1105 in which the digital watermark is embedded is the confidential electronic file.

In the present embodiment, the checking unit 5001 checks whether the electronic file 1105 in which the digital watermark is included has been deleted from the storage unit 1104 or not. In case where the electronic file 1105 in which the digital watermark is included does not exist in the storage unit 1104, the checking unit 5001 determines that the confidential electronic file has been deleted from the storage unit 1104. Then the checking unit 5001 transmits the file deletion notification for notification that the electronic file 1105 (confidential electronic file) in which the digital watermark is included has been deleted, to the security monitoring device 1001.

The file deletion notification is the same as the file deletion notification described in Embodiment 1. Operations posterior to the reception of the file deletion notification by the security monitoring device 1001 are the same as the operations described in Embodiment 1 and description is omitted.

### Description on Effects of Embodiment

In the embodiment, as described above, the file deletion notification is automatically transmitted from the terminal device when the confidential electronic file is deleted from the terminal device. Upon deletion of the confidential electronic file, therefore, the terminal device is immediately made possible to communicate with the other devices in the second network or with devices in the other networks. In the present embodiment, since the digital watermark is embedded in the confidential electronic file, the terminal device is capable of reliably detecting the deletion of the confidential electronic file.

Though the embodiments of the invention have been described above, a combination of two or more out of the embodiments may be embodied.

Alternatively, one of the embodiments may be partially embodied.

Alternatively, a partial combination of two or more out of the embodiments may be embodied.

The invention is not limited to these embodiments and various modifications thereto may be made as appropriate.

*** Description on Hardware Configuration ***

Finally, supplementary description on the hardware configuration of the security monitoring device 1001 will be given.

The processor 7001 illustrated in FIG. 12 is an IC (Integrated Circuit) that carries out processing.

The processor 7001 is a CPU (Central Processing Unit), a DSP (Digital Signal Processor), or the like.

The storage device 7002 illustrated in FIG. 12 is a RAM (Random Access Memory), a ROM (Read Only Memory), a flash memory, an HDD (Hard Disk Drive), or the like.

The communication device 7003 illustrated in FIG. 12 includes a receiver that receives data and a transmitter that transmits data.

The communication device 7003 is a communication chip or an NIC (Network Interface Card), for instance.

An OS (Operating System) is also stored in the storage device 7002.

At least a portion of the OS is executed by the processor 7001.

While executing at least the portion of the OS, the processor 7001 executes the programs that fulfil the functions of the electronic file copy notification reception unit 1002 and the determination instruction unit 1003.

While one processor is illustrated in FIG. 12, the security monitoring device 1001 may include a plurality of processors.

Information, data, signal values, variable values, and the like that indicate results of processing in the electronic file copy notification reception unit 1002 and the determination instruction unit 1003 are stored in the storage device 7002 or a register or a cache memory in the processor 7001.

The programs that fulfil the functions of the electronic file copy notification reception unit 1002 and the determination instruction unit 1003 may be stored in a portable storage medium such as a magnetic disk, a flexible disk, an optical disk, a compact disk, a Blu-ray (a registered trademark) disk, or a DVD.

The “units” in the electronic file copy notification reception unit 1002 and the determination instruction unit 1003 may be read as “circuits”, “steps”, “procedures”, or “processing”.

The security monitoring device 1001 may be implemented by an electronic circuit such as a logic IC (Integrated Circuit), a GA (Gate Array), an ASIC (Application Specific Integrated Circuit), or an FPGA (Field-Programmable Gate Array).

In this case, the electronic file copy notification reception unit 1002 and the determination instruction unit 1003 are each implemented as a portion of the electronic circuit.

The processor and the electronic circuits may be collectively referred to as processing circuitry.

### REFERENCE SIGNS LIST

1001: security monitoring device; 1002: electronic file copy notification reception unit; 1003: determination instruction unit; 1004: storage unit; 1005: confidentiality retaining terminal record table; 1101: terminal device; 1102: electronic file acquisition unit; 1103: connection request unit; 1104: storage unit; 1105: electronic file; 1201: file server; 1202: electronic file transmission unit; 1203: electronic file copy detection unit; 1204: storage unit; 1205: electronic file; 1301: first network switch; 1302: connection restriction unit; 3001: second network switch; 3002: connection restriction unit; 5001: checking unit; 6001: digital watermark embedding unit; 7001: processor; 7002: storage device; 7003: communication device

1. A security monitoring device comprising:
processing circuitry to:
acquire identification information on a terminal device connected to a first network switch to which a file server is connected, as first identification information, when the terminal device acquires a copy of an electronic file from the file server;
acquire identification information on a device, as second identification information, when the device is newly connected to a second network switch different from the first network switch; and
match the first identification information with the second identification information and to instruct the second network switch to restrict communication to and from the terminal device via the second network switch in case where the first identification information coincides with the second identification information.

2. The security monitoring device according to claim 1, wherein
the processing circuitry instructs the second network switch to lift restriction on the communication to and from the terminal device when notified by the terminal device that the copy of the electronic file has been deleted from the terminal device.

3. The security monitoring device according to claim 1, wherein
the processing circuitry acquires the identification information on the terminal device as the first identification information when the terminal device acquires a confidential electronic file from the file server.

4. A communication system comprising:
a terminal device including processing circuitry to acquire a copy of an electronic file from a file server connected to a first network switch, when connected to the first network switch; and
a security monitoring device including
processing circuitry to:
acquire identification information on the terminal device as first identification information, when the terminal device acquires the copy of the electronic file from the file server,
acquire identification information on a device, as second identification information, when the device is newly connected to a second network switch different from the first network switch, and
match the first identification information with the second identification information and to instruct the second network switch to restrict communication to and from the terminal device via the second network switch in case where the first identification information coincides with the second identification information.

5. The communication system according to claim 4, wherein
the processing circuitry of the terminal device checks whether the electronic file has been deleted from the terminal device or not and to notify the security monitoring device that the electronic file has been deleted from the terminal device in case where the electronic file has been deleted from the terminal device, and
the processing circuitry of the security monitoring device instructs the second network switch to lift restriction on the communication to and from the terminal device when notified by the terminal device that the copy of the electronic file has been deleted from the terminal device.

6. The communication system according to claim 5, wherein
the processing circuitry of the terminal device, upon acquisition of the copy of the electronic file in which a specific character string is included, checks whether the copy of the electronic file in which the specific character string is included has been deleted from the terminal device or not and notifies the security monitoring device that the copy of the electronic file in which the specific character string is included has been deleted from the terminal device in case where the copy of the electronic file in which the specific character string is included has been deleted from the terminal device, and
the processing circuitry of the terminal device, upon acquisition of the copy of the electronic file having a specific file name, checks whether the copy of the electronic file having the specific file name has been deleted from the terminal device or not and notifies the security monitoring device that the copy of the electronic file having the specific file name has been deleted from the terminal device in case where the copy of the electronic file having the specific file name has been deleted from the terminal device.

7. The communication system according to claim 5, wherein
the processing circuitry of the terminal device, upon acquisition of the copy of the electronic file in which a digital watermark is included, checks whether the copy of the electronic file in which the digital watermark is included has been deleted from the terminal device or not and notifies the security monitoring device that the copy of the electronic file in which the digital watermark is included has been deleted from the terminal device in case where the copy of the electronic file in which the digital watermark is included has been deleted from the terminal device.

8. A security monitoring method comprising:
acquiring identification information on a terminal device connected to a first network switch to which a file server is connected, as first identification information, when the terminal device acquires a copy of an electronic file from the file server;
acquiring identification information on a device, as second identification information, when the device is newly connected to a second network switch different from the first network switch; and
matching the first identification information with the second identification information and instructing the second network switch to restrict communication to and from the terminal device via the second network switch in case where the first identification information coincides with the second identification information.

9. A non-transitory computer readable medium storing a security monitoring program that causes a computer to execute:
a first identification information acquisition process of acquiring identification information on a terminal device connected to a first network switch to which a file server is connected, as first identification information, when the terminal device acquires a copy of an electronic file from the file server;
a second identification information acquisition process of acquiring identification information on a device, as second identification information, when the device is newly connected to a second network switch different from the first network switch; and
a restriction instruction process of matching the first identification information with the second identification information and instructing the second network switch to restrict communication to and from the terminal device via the second network switch in case where the first identification information coincides with the second identification information.
